(19) United States
(12) Patent Application Publication
(10) Pub. No.: US 2026/0008662 A1
(43) Pub. Date: Jan. 8, 2026

(54) WATER DISPENSER WITH A MANIFOLD DEVICE

(71) Applicant: Efraim SHMUEL, Jerusalem (IL)

(72) Inventors: Daniel VALADI, Holon (IL); Amihay AVITAL, Petach Tikva (IL)

(73) Assignee: Efraim SHMUEL, Jerusalem (IL)

(21) Appl. No.: 19/256,212

(22) Filed: Jul. 1, 2025

(30) Foreign Application Priority Data
Jul. 2, 2024 (IL) 314088

(51) Int. Cl. B67D 1/00; B67D 1/08; B67D 1/12

(52) U.S. Cl. CPC B67D 1/0004; B67D 1/0082; B67D 1/0085; B67D 1/0895; B67D 1/1202; B67D 2001/0088; B67D 2001/0089; B67D 2001/0095

(57) ABSTRACT

A water dispenser, comprising a hot water tank and a cold water tank; a water outlet configured to output water; activation interface, and a manifold device. The manifold device comprising a hot water inlet configured to receive hot water from a hot water tube; a cold water inlet configured to receive cold water from a cold water tube; a manifold outlet coupled to the water outlet; a passage mechanism for controlling a flow of water from the manifold device towards the water outlet.

### FIELD OF THE INVENTION

The subject matter generally relates to dispensing and heating water.

### CROSS REFERENCE TO RELATED APPLICATIONS

This application claims priority from IL Application No. 314088 filed on Jul. 2, 2024, which is incorporated herein by reference in its entirety.

### BACKGROUND OF THE INVENTION

Water dispensers provides available water consumed for drinking, cooking, cleaning, and also in industries, for example for sanitation. Water dispensers come in various types, each designed to meet different needs and preferences. Here are a few examples, 1. Bottled Water Dispenser that uses large water bottles, typically placed upside down on the dispenser. 2. Point-of-Use (POU) Water Dispenser, directly connected to a water supply line, eliminating the need for bottled water. They often include filtration systems to purify tap water before dispensing. Many types of water dispensers provide both hot water and cold water and have two separate faucets or spigots for dispensing hot and cold water. Some models may include a heating element and a cooling system to maintain water temperature.

The water dispenser for residential use is mostly located in a kitchen, where the size is limited, hence the standard width of the dispenser is limited, for example at 40 centimeters. Yet, many families and organizations desire to have a large amount of hot water or cold water available, for example over 3 liters. The dispenser's volume is much more than 3 liters, but other components in the dispenser, such as water tubes, electrical circuitry, and others, limit the amount of water available inside the dispenser. There is a need to increase the amount of water inside the water dispenser without increasing the dispenser's volume.

### SUMMARY OF THE INVENTION

The subject matter discloses a water dispenser, comprising a hot water tank and a cold water tank; a water outlet configured to output water; activation interface, a manifold device, comprising: a hot water inlet configured to receive hot water from a hot water tube; a cold water inlet configured to receive cold water from a cold water tube; a manifold outlet coupled to the water outlet; a passage mechanism for controlling a flow of water from the manifold device towards the water outlet.

In some cases, the passage mechanism further comprises a hot water manifold lever physically coupled to a hot water activation button and a cold water manifold lever physically coupled to a cold water activation button. In some cases, the hot water manifold lever and the cold water manifold lever have a first state that enables passage of water towards the water outlet and a second state that prevents passage of water towards the water outlet.

In some cases, the passage mechanism is coupled to the activation interface, such that when a user activates the activation interface, the passage mechanism moves accordingly and water flows via the water outlet.

In some cases, the manifold device comprises a cold water solenoid and a hot water solenoid configured to pump water from water tubes connected to the hot water tank and the cold water tank. In some cases, one of the solenoids is configured to produce more energy, to pump water from a lower origin. In some cases, the manifold device comprises a body and passageways configured to store the water inside the body.

In some cases, the manifold outlet comprises a cold water manifold outlet for outputting cold water and a hot water manifold outlet for outputting hot water. In some cases, the water dispenser further comprises a hot water manifold gasket configured to block a cross-section of the hot water manifold outlet, wherein the hot water manifold gasket is movable when the hot water manifold lever moves.

In some cases, the water dispenser further comprises a cold water manifold gasket configured to block a cross-section of the cold water manifold outlet, wherein the cold water manifold gasket is movable when the cold water manifold lever moves.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a water dispenser having a manifold device, according to exemplary embodiments of the invention.

FIGS. 2A-2C show a manifold device from various angles, according to exemplary embodiments of the subject matter.

FIGS. 3A-3B show a manifold device enabling and disabling water to pass toward the water outlet, according to exemplary embodiments of the subject matter.

### DETAILED DESCRIPTION

The subject matter described herein discloses a water dispenser comprising a manifold device having inlets for receiving cold water and hot water and for outputting cold water and hot water to a water faucet of the water dispenser. In some cases, the manifold device may output the hot water to a hot water faucet and cold water to a cold faucet. The manifold device comprises activation levers that enable the flow of water from the manifold device toward the faucet or faucets. The manifold device is coupled to the activation devices of the water dispenser, such that when the user of the water dispenser moves or otherwise accesses the activation devices, the respective activation levers move, thereby enabling the flow of water.

The manifold device comprises multiple inlets and multiple outlets. The manifold device may be defined as a central hub for directing the flow of fluid from two inlet tubes connecting the manifold device to the hot water tank and the cold water tank of the water dispenser to one water outlet or multiple water outlets, such as faucets. The manifold device acts as an intermediary device for controlling the distribution and flow of water in the water dispenser.

The manifold device comprises multiple entry points where water from different sources enters the manifold.

The manifold device comprises multiple exit points where fluid is directed to one or more destinations. The manifold device comprises internal pathways or channels within the manifold device that guide the flow of water from the inlets to the outlets. The manifold device comprises flow control mechanisms such as valves, regulators, or flow meters integrated into the manifold device to adjust the flow rates from individual inlets or outlets as needed. The manifold device comprises a manifold body defined as the physical structure or housing that contains and organizes the inlet ports, the outlet ports, and internal pathways or channels, as well as the internal components facilitating fluid distribution.

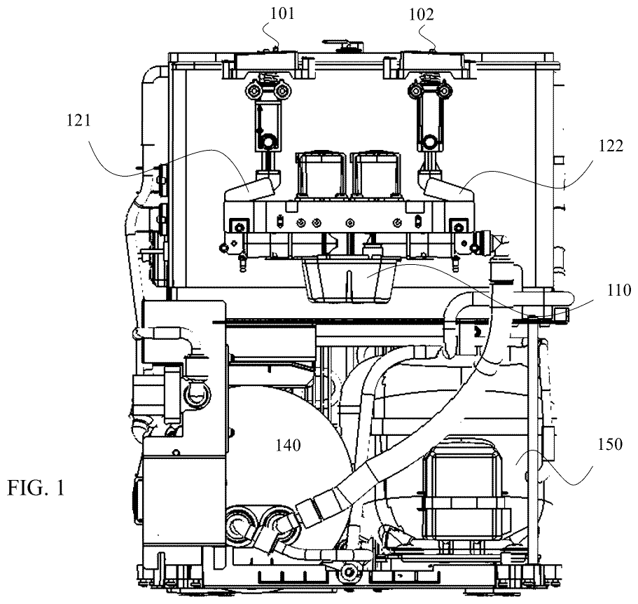

FIG. 1 shows a water dispenser having a manifold device, according to exemplary embodiments of the invention. The water dispenser comprises a hot water activation interface, for example activation button 101 configured to be operated by a user of the water dispenser when the user desires the water dispenser to output hot water. The water dispenser may comprise an electric hot water activation button 101 and a mechanic hot water activation button 101 used on Shabbat days and holidays. The hot water activation button 101 may be a button, a switch, a knob and any other mechanism used to move a component in the water dispenser that allows passage of water from a hot water container to a water outlet 110 of the water dispenser.

The water dispenser comprises a cold water activation button 102 configured to be operated by a user of the water dispenser when the user desires the water dispenser to output cold water. The water dispenser may comprise an electric cold water activation button 102 and a mechanic cold water activation button 102 used on Shabbat days and holidays. The cold water activation button 102 may be a button, a switch, a knob and any other mechanism used to move a component in the water dispenser that allows passage of water from a cold water container to a water outlet 110 of the water dispenser.

The water dispenser comprises a hot water tank 140 configured to store hot water and a cold water tank 150 configured to store cold water. The water dispenser comprises a water heater configured to heat the water in the hot water tank 140. The hot water tank 140 and the cold water tank 150 may comprise water inlets configured to enable water to enter the water tanks 140 and 150, for example from the water grid.

The water dispenser comprises a housing configured to house the water tanks 140 and 150. The housing may include a user interface, for example a screen, configured to show information. The housing may be made of plastics, metal or a combination thereof. The housing may comprise a base configured to be placed on a surface, sidewalls extending upwards from the base and a ceiling covering the water dispenser's components from above. The water dispenser comprises circuitry, such as sensors, controller, wireless communication unit either via wi-fi, Bluetooth, and the like.

The water dispenser comprises a manifold device 130 configured to regulate water flow in the water dispenser. The manifold device 130 is made of materials designed to store water, for example, plastics, metals, and the like. The manifold device 130 comprises a hot water inlet configured to receive hot water from a hot water tube. The hot water tube is connected on one end to the hot water tank 140 and on the other end to the hot water inlet of the manifold device 130. In some cases, hot water flows into the hot water inlet after hot water flows from the manifold device 130 to the water outlet 110. The manifold device 130 comprises a cold water inlet configured to receive cold water from a cold water tube. The cold water tube is connected on one end to the cold water tank 150 and on the other end to the cold water inlet of the manifold device 130. In some cases, cold water flows into the cold water inlet after cold water flows from the manifold device 130 to the water outlet 110. The manifold device 130 comprises passageways configured to store water and to enable water to flow therein towards the water outlet. In some exemplary cases, the manifold device 130 may comprise a single water outlet 110 configured to enable flow of both cold water and hot water. In some exemplary cases, the manifold device 130 may comprise multiple water outlets 110, a first water outlet is configured to enable flow of cold water and a second water outlet is configured to enable flow of hot water.

In some cases, the manifold device 130 comprises a passage mechanism that enables water to flow from the passageways inside the manifold device 130 towards the water outlet 110. The passage mechanism is coupled to the activation buttons 101 and 102, such that when the user presses or otherwise activates the activation buttons 101 and 102, the passage mechanism moves accordingly and water flows via the water outlet 110. The passage mechanism may include hot water manifold lever 121 physically coupled to the hot water activation button 101 and a cold water manifold lever 122 physically coupled to the cold water activation button 102. Thus, moving the hot water activation button 101 results in the movement of the hot water manifold lever 121, enabling the flow of hot water toward the water outlet 110. Similarly, moving the cold water activation button 102 results in the movement of the cold water manifold lever 122, enabling the flow of cold water toward the water outlet 110.

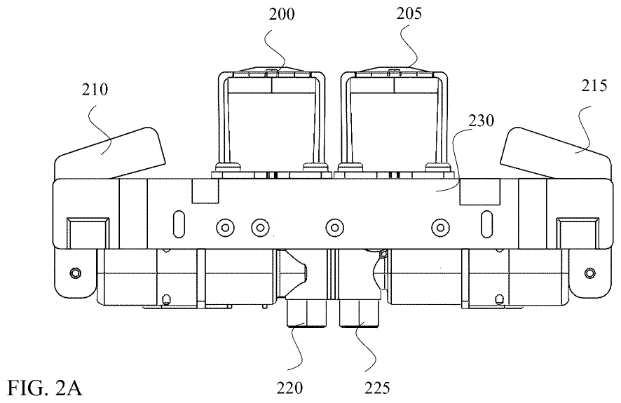

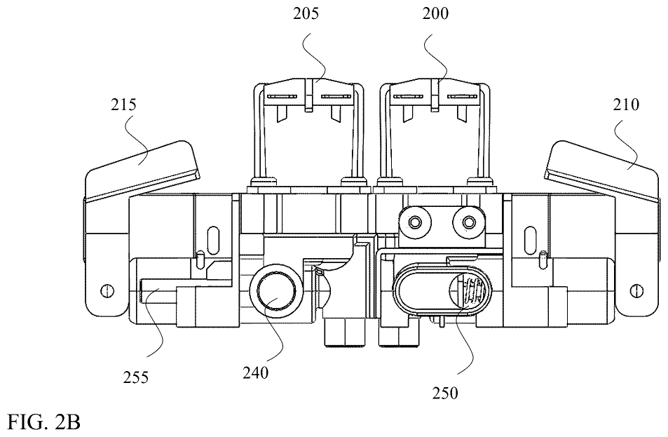

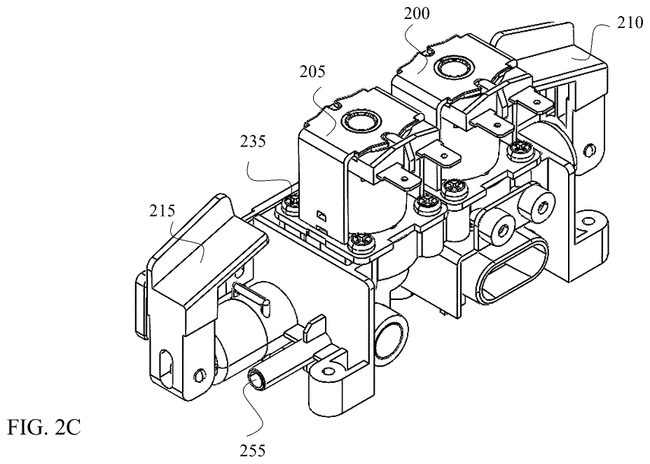

FIGS. 2A-2C show a manifold device from various angles, according to exemplary embodiments of the subject matter. FIG. 2A shows the manifold device from a front view, FIG. 2B shows the manifold device from a rear view and FIG. 2C shows the manifold device from a perspective view. The manifold device comprises a manifold body 230 configured to form a structure for the components of the manifold device. The manifold body 230 may be of a three-dimensional polygonal shape such as a cube or a rectangular cuboid, or any type of ellipsoid and the like. The manifold body comprises niches, grooves, protrusions, or other types of shapes configured to enable connections of other components, for example using screws, nuts, bolts, and the like.

The manifold device comprises a cold water manifold lever 215 configured to be coupled to an activation button of the water dispenser. The cold water manifold lever 215 is movable, for example in a linear movement of circular movement around a joint. The cold water manifold lever 215 have a disable state in which the cold water manifold lever 215 prevents the flow of water towards the water cold outlet 225 and an enable state in which the cold water manifold lever 215 enables the flow of water towards the cold water outlet 225.

The manifold device comprises a hot water manifold lever 210 configured to be coupled to an activation button of the water dispenser. The hot water manifold lever 210 is movable, for example in a linear movement of circular movement around a joint. The hot water manifold lever 210 have a disable state in which the hot water manifold lever 210 prevents the flow of water towards the hot water outlet 220 and an enable state in which the cold water manifold lever 215 enables the flow of water towards the cold water outlet 220.

The manifold device comprises a cold water solenoid 205 and a hot water solenoid 200 located on a body top surface 235 of the manifold device. The solenoids 200, 205 are electromechanical devices that convert electrical energy into linear motion. They may comprise a coil of wire wound around a cylindrical core, which produces a magnetic field when current flows through the coil, resulting in the movement of a plunger or armature. The solenoids 200, 205 may be used to pump water from the water tubes connected to the water tanks 140 and 150. In some cases, one of the solenoids 200, 205 may be configured to produce more energy, to pump water from a lower origin.

The manifold device comprises a hot water inlet 250 and a cold water inlet 255 configured to receive hot water and cold water, respectively, via a tube coupled to the water tanks 140 and 150. In some cases, The manifold device comprises a cork 240 configured to regulate water inside the manifold device and allow access to the passageways inside the manifold device.

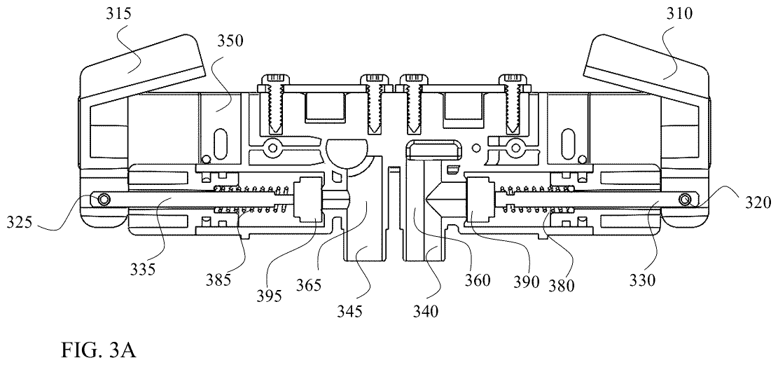

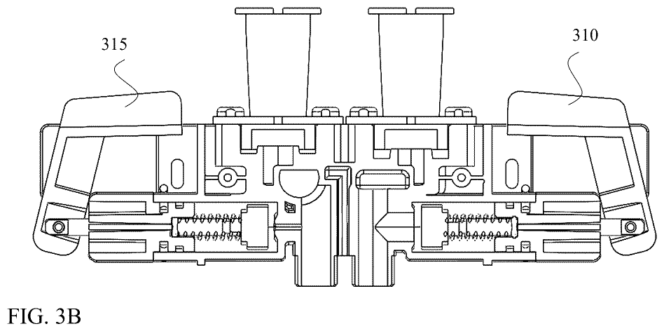

FIGS. 3A-3B show a manifold device enabling and disabling water to pass toward the water outlet, according to exemplary embodiments of the subject matter. The manifold device comprises a manifold body 350 similar to the manifold body 230 described above.

The manifold device comprises a hot water manifold outlet The manifold device comprises a hot water manifold lever 310 and a cold water manifold lever 315. The levers 310, 315 move when the activation buttons of the water dispenser are activated or maneuvered or operated by the user of the water dispenser. The levers 310, 315 are physically coupled to the manifold body 350, for example using a screw or other securing mechanism desired by a person skilled in the art.

360 and a cold water manifold outlet 365. Hot water flows from the manifold device towards the water outlet of the water dispenser via the hot water manifold outlet 360. Similarly, cold water flows from the manifold device towards the water outlet of the water dispenser via the cold water manifold outlet 365.

The hot water manifold outlet 360 is fluidly coupled to a hot water manifold passageway 340, configured to store the water received from the hot water tank via the hot water inlet. Similarly, the cold water manifold outlet 365 is fluidly coupled to a cold water manifold passageway 345, configured to store the water received from the hot water tank via the hot water inlet. The hot water manifold outlet 360 and the cold water manifold outlet 365 have an open state in which water from the respective passageway can flow toward the water outlet and a closed state in which water from the respective passageway cannot flow toward the water outlet. The open state and the closed state may be affected by a position of the levers 310, 315, or from a movement of another component of technique desired by a person skilled in the art.

In the exemplary embodiment of FIGS. 3A and 3B, the hot water manifold outlet 360 and the cold water manifold outlet 365 are in the open state when the respective lever is pushed downwards. For example, the movement of the hot water manifold lever 310 changes the state of the hot water manifold outlet 360 from open to closed and vice versa. Similarly, the movement of the cold water manifold lever 315 changes the state of the cold water manifold outlet 365 from open to closed and vice versa.

In some exemplary cases, the hot water manifold outlet 360 prevents water from flowing towards the water outlet because a hot water manifold gasket 330 blocks the cross-section of the hot water manifold outlet 360. The hot water manifold gasket 330 is movable when the hot water manifold lever 310 moves. The hot water manifold gasket 330 may be physically coupled to the hot water manifold lever 310 using a hot water manifold joint 320. The joint 320 converts a circular movement of the hot water manifold lever 310 to a linear movement of the hot water manifold gasket 330 that enables the water to flow from the hot water manifold passageway 340 to the hot water manifold outlet 360 and to the water outlet of the water dispenser. Similarly, cold water manifold joint 325 connects the cold water manifold gasket to the cold water manifold lever 315, such that movement of the cold water manifold lever 315 enables water to flow from the cold water manifold passageway 345 to the cold water manifold outlet 365 and to the water outlet of the water dispenser.

The hot water manifold gasket 330 is coupled to a hot water gasket spring 380 configured to retract the hot water manifold gasket 330 to seal the hot water manifold passageway 340 after water flows therein. Similarly, the cold water manifold gasket 335 is coupled to a cold water gasket spring 385 configured to retract the hot water manifold gasket 335 to seal the hot water manifold passageway 340 after water flows therein. That is, the springs 380, 385 shrink, meaning that their length is decreased, when water is dispensed from the water dispenser.

In some exemplary cases, the hot water manifold gasket 330 is couped to a hot silicon end 390 configured to seal the hot water manifold passageway 340. Similarly, the cold water manifold gasket 335 may be couped to a cold silicon end 395 configured to seal the cold water manifold passageway 345.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the invention. To the extent that section headings are used, they should not be construed as necessarily limiting.

1. A water dispenser, comprising:
a hot water tank and a cold water tank;
a water outlet configured to output water;
activation interface,
a manifold device, comprising:
a hot water inlet configured to receive hot water from a hot water tube;
a cold water inlet configured to receive cold water from a cold water tube;
a manifold outlet coupled to the water outlet;
a passage mechanism for controlling a flow of water from the manifold device towards the water outlet.

2. The water dispenser of claim 1, wherein the passage mechanism further comprises a hot water manifold lever physically coupled to a hot water activation button and a cold water manifold lever physically coupled to a cold water activation button.

3. The water dispenser of claim 2, wherein the hot water manifold lever and the cold water manifold lever have a first state that enables passage of water towards the water outlet and a second state that prevents passage of water towards the water outlet.

4. The water dispenser of claim 1, wherein the passage mechanism is coupled to the activation interface, such that when a user activates the activation interface, the passage mechanism moves accordingly and water flows via the water outlet.

5. The water dispenser of claim 1, wherein the manifold device comprises a cold water solenoid and a hot water solenoid configured to pump water from water tubes connected to the hot water tank and the cold water tank.

6. The water dispenser of claim 5, wherein one of the cold water solenoid and the hot water solenoids is configured to produce more energy, to pump water from a lower origin.

7. The water dispenser of claim 1, wherein the manifold device comprises a body and passageways configured to store the water inside the body.

8. The water dispenser of claim 2, wherein the manifold outlet comprises a cold water manifold outlet for outputting cold water and a hot water manifold outlet for outputting hot water.

9. The water dispenser of claim 8, further comprises a hot water manifold gasket configured to block a cross-section of the hot water manifold outlet, wherein the hot water manifold gasket is movable when the hot water manifold lever moves.

10. The water dispenser of claim 8, further comprises a cold water manifold gasket configured to block a cross-section of the cold water manifold outlet, wherein the cold water manifold gasket is movable when the cold water manifold lever moves.
